(19) United States
(12) Patent Application Publication
(10) Pub. No.: US 2024/0329577 A1
(43) Pub. Date: Oct. 3, 2024

(54) FIXING DEVICE AND IMAGE FORMING APPARATUS

(71) Applicant: FUJIFILM Business Innovation Corp., Tokyo (JP)

(72) Inventors: Ayuka NASU, Yokohama-shi (JP); Toko HARA, Yokohama-shi (JP); Toru INOUE, Yokohama-shi (JP); Mizuki SUGINO, Ebina-shi (JP); Kiyoshi KOYANAGI, Ebina-shi (JP)

(73) Assignee: FUJIFILM Business Innovation Corp., Tokyo (JP)

(21) Appl. No.: 18/362,182

(22) Filed: Jul. 31, 2023

(30) Foreign Application Priority Data
Mar. 29, 2023 (JP) 2023-052829

(51) Int. Cl. G03G 15/20

(52) U.S. Cl. CPC G03G 15/2053; G03G 15/2064; G03G 2215/2038

(57) ABSTRACT

A fixing device includes an endless-belt-shaped fixing section that is rotatably provided; a supporting section that is disposed inside the fixing section and that supports an inner peripheral surface of the fixing section; a pressure contact section that is in pressure contact with the supporting section at a fixing nip portion via the fixing section; a lubricant that is interposed between the supporting section and the fixing section; and a lubricant storing portion that is provided at an inlet of the fixing nip portion of the supporting section such that a width of a gap between the fixing section and the lubricant storing portion gradually decreases along a rotational direction of the fixing section and that stores the lubricant.

### CROSS-REFERENCE TO RELATED APPLICATIONS

This application is based on and claims priority under 35 USC 119 from Japanese Patent Application No. 2023-052829 filed Mar. 29, 2023.

### BACKGROUND

### (i) Technical Field

The present invention relates to a fixing device and an image forming apparatus.

### (ii) Related Art

In the related art, as techniques related to fixing devices, for example, fixing devices disclosed in JP2005-242113A, JP2006-178315A, JP2005-156910A, or the like have already been proposed.

In JP2005-242113A, in a configuration in which an inner surface of a belt is provided with a spiral groove, a lubricant is applied between the belt and a sliding member, and a space between the belt, the sliding member, and a supporting member is provided at least on an upstream side with respect to a nip in a belt rotational direction, the sectional area of the space is different between a central portion and an end portion in a longitudinal direction.

In JP2006-178315A, a first projection is provided on a supporting member to be provided on a downstream side with respect to a heating member in a heat transfer material rotational direction and to have a length approximately equal to a length of an image formation region, a recess that does not come into contact with a heat transfer material is provided on the downstream side with respect to the first projection, a second projection having a length approximately equal to a length of the image formation region is provided on the downstream side with respect to the recess and outside a nip portion, and the second projection is provided with a slit in a heat transfer material movement direction.

In JP2005-156910A, in a configuration in which a lubricant is applied between a belt and a sliding member and a space between the belt, the sliding member, and a supporting member is provided at least on an upstream side with respect to a nip, the sectional area of the space is different between a central portion and an end portion in a longitudinal direction.

### SUMMARY

Aspects of non-limiting embodiments of the present disclosure relate to a fixing device and an image forming apparatus with which it is possible to suppress the occurrence of gloss unevenness on a recording medium accompanied by a decrease in amount of a lubricant interposed between a supporting section and a fixing section in comparison with a case where a lubricant storing portion provided at an inlet of a fixing nip portion of the supporting section is not provided.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including an endless-belt-shaped fixing section that is rotatably provided; a supporting section that is disposed inside the fixing section and that supports an inner peripheral surface of the fixing section; a pressure contact section that is in pressure contact with the supporting section at a fixing nip portion via the fixing section; a lubricant that is interposed between the supporting section and the fixing section; and a lubricant storing portion that is provided at an inlet of the fixing nip portion of the supporting section such that a width of a gap between the fixing section and the lubricant storing portion gradually decreases along a rotational direction of the fixing section and that stores the lubricant.

### BRIEF DESCRIPTION OF THE DRAWINGS

Exemplary embodiment(s) of the present invention will be described in detail based on the following figures, wherein:

FIG. 1 is an overall configuration diagram showing an image forming apparatus to which a fixing device according to Exemplary Embodiment 1 of the present invention is applied;

FIG. 2 is a cross-sectional configuration diagram showing the fixing device according to Exemplary Embodiment 1 of the present invention;

FIG. 3 is a cross-sectional configuration diagram showing a heating belt;

FIG. 4 is a plan configuration diagram showing heat-generating portions of a ceramic heater;

FIG. 5 is a cross-sectional configuration diagram showing the ceramic heater;

FIG. 6 is a graph showing the heat generation temperature of the ceramic heater;

FIG. 7 is a schematic diagram showing the operation of a fixing device in the related art;

FIG. 8 is a schematic diagram showing the operation of the fixing device in the related art;

FIG. 9 is a cross-sectional configuration diagram showing a major part of the fixing device according to Exemplary Embodiment 1 of the present invention;

FIG. 10 is an enlarged view of a major part of FIG. 9; and

FIG. 11 is a major part-enlarged view showing the operation of the fixing device according to Exemplary Embodiment 1 of the present invention.

### DETAILED DESCRIPTION

Hereinafter, exemplary embodiments of the present invention will be described with reference to the drawings.

### Exemplary Embodiment 1

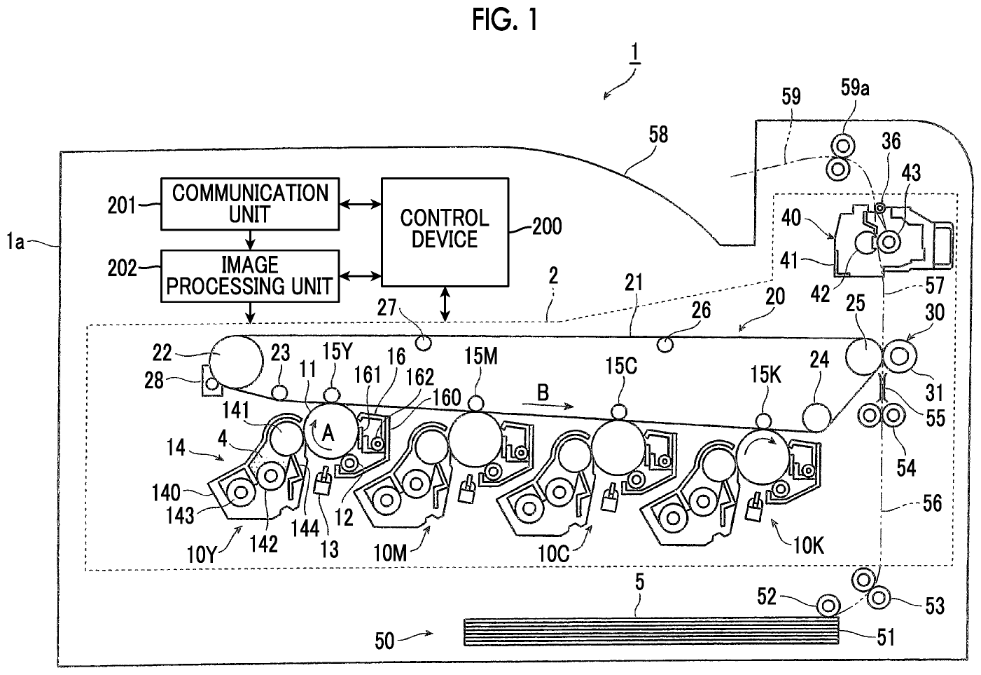

FIG. 1 shows an image forming apparatus to which a fixing device according to Exemplary Embodiment 1 is applied.

### Overall Configuration of Image Forming Apparatus

An image forming apparatus 1 according to Exemplary Embodiment 1 is configured as, for example, a color printer. The image forming apparatus 1 includes a plurality of image creating devices 10 that form toner images developed with a toner constituting a developer 4, an intermediate transfer device 20 that holds a toner image formed by each image creating device 10 and finally transports the held toner image to a secondary transfer position where the transported toner image is secondarily transferred to recording paper 5 serving as an example of a recording medium, a paper feed device 50 that accommodates and transports required recording paper 5 to be supplied to the secondary transfer position of the intermediate transfer device 20, a fixing device 40 that fixes the toner image on the recording paper 5 secondarily transferred by the intermediate transfer device 20 and that serves as an example of a fixing section, and the like. The plurality of image creating devices 10 and the intermediate transfer device 20 constitute an image forming section 2 that forms an image on the recording paper 5. In addition, 1a in the figure indicates an apparatus body of the image forming apparatus 1, and the apparatus body 1a is formed of a supporting structural member, an exterior cover, and the like. Additionally, a two-dot chain line in the figure indicates a major transport route along which the recording paper 5 is transported in the apparatus body 1a. The image forming section 2 is not limited to an image forming section that forms a full-color image, and it is a matter of course that the image forming section 2 may be an image forming section that forms a monochrome image.

The image creating devices 10 include four image creating devices 10Y, 10M, 10C, and 10K that exclusively form toner images in four colors of yellow (Y), magenta (M), cyan (C), and black (K), respectively. The four image creating devices 10 (Y, M, C, K) are disposed to be arranged in a row in an inclined state in an internal space of the apparatus body la.

The four image creating devices 10 include yellow (Y), magenta (M), and cyan (C) color image creating devices 10 (Y, M, C) and a black (K) image creating device 10K. The black image creating device 10K is disposed on the most downstream side along a movement direction B of an intermediate transfer belt 21 of the intermediate transfer device 20. The image forming apparatus 1 includes, as image forming modes, a full-color mode in which the color image creating devices 10 (Y, M, C) and the black (K) image creating device 10K are operated to form a full-color image, and a black-and-white mode in which only the black (K) image creating device 10K is operated to form a black-and-white (monochrome) image.

As shown in FIG. 1, each of the image creating devices 10 (Y, M, C, K) includes a rotating photoconductive drum 11 serving as an example of an image holder, and each device serving as an example of the following toner image forming section is disposed around the photoconductive drum 11 as major devices. The major devices are a charging device 12 that charges a peripheral surface (image holding surface) of the photoconductive drum 11, on which an image can be formed, to a required potential, an exposure device 13 that irradiates the charged peripheral surface of the photoconductive drum 11 with light based on information (signal) of an image to form an electrostatic latent image (for each color) having a potential difference, a developing device 14 (Y, M, C, K) that develops the electrostatic latent image with a toner of the developer 4 for a corresponding color (Y, M, C, K) to form a toner image, a primary transfer device 15 (Y, M, C, K) that transfers each toner image to the intermediate transfer device 20 and that serves as an example of a primary transfer section, and a drum cleaning device 16 (Y, M, C, K) that remove and clean a deposit such as the toner remaining on and adhering to the image holding surface of the photoconductive drum 11 after primary transfer.

The photoconductive drum 11 has an image holding surface having a photoconductive layer (photosensitive layer) made of a photosensitive material formed on a peripheral surface of a cylindrical or columnar base material to be subjected to ground treatment. The photoconductive drum 11 is supported such that power is transmitted thereto from a drive device (not shown) and the photoconductive drum 11 rotates in a direction indicated by arrow A.

The charging device 12 includes a contact type charging roll that is disposed in contact with the photoconductive drum 11. A charging voltage is supplied to the charging device 12. As the charging voltage, in a case where the developing device 14 performs reverse development, a voltage or current having the same polarity as the charging polarity of the toner supplied from the developing device 14 is supplied. In addition, as the charging device 12, a non-contact type charging device such as a scorotron disposed on the surface of the photoconductive drum 11 in a non-contact state may be used.

The exposure device 13 consists of an LED printhead that irradiates the photoconductive drum 11 with the light according to the image information by light emitting diodes (LEDs) serving as a plurality of light emitting elements arranged in an axial direction of the photoconductive drum 11 to form an electrostatic latent image. Note that, a device that performs deflection and scanning along the axial direction of the photoconductive drum 11 with laser light configured according to the image information may be used as the exposure device 13.

All of the developing devices 14 (Y, M, C, K) are configured such that a developing roll 141 that holds the developer 4 to transport the developer 4 to a developing region that faces the photoconductive drum 11, agitating and transporting members 142 and 143 such as two screw augers that transports the developer 4 to pass through the developing roll 141 while agitating the developer 4, a layer thickness regulating member 144 that regulates the amount (layer thickness) of the developer held on the developing roll 141, and the like are disposed inside a housing 140 in which an opening portion and an accommodation chamber of the developer 4 are formed. A developing voltage is supplied to the developing device 14 from a power supply device (not shown) between the developing roll 141 and the photoconductive drum 11. Additionally, the developing roll 141 and the agitating and transporting members 142 and 143 rotate in a required direction with power transmitted thereto from a drive device (not shown). Furthermore, as the four-color developers 4 (Y, M, C, K), two-component developers containing a non-magnetic toner and a magnetic carrier are used.

The primary transfer device 15 (Y, M, C, K) is a contact type transfer device including a primary transfer roll that rotates around the photoconductive drum 11 in contact therewith via the intermediate transfer belt 21 and is supplied with a primary transfer voltage. As the primary transfer voltage, a direct-current voltage indicating a polarity opposite to the charging polarity of the toner is supplied from the power supply device (not shown).

The drum cleaning device 16 includes a container-shaped main body 160 that partially opens, a cleaning plate 161 that is disposed to be in contact with the peripheral surface of the photoconductive drum 11 after the primary transfer at a required pressure and removes and cleans deposits such as residual toner, a delivery member 162 such as a screw auger that recovers the deposits such as toner removed by the cleaning plate 161 and transports the deposits for delivery to a recovery system (not shown), and the like. As the cleaning plate 161, a plate-shaped member (for example, a blade) made of a material such as rubber is used.

As shown in FIG. 1, the intermediate transfer device 20 is disposed to be present at a position above each image creating device 10 (Y, M, C, K). The intermediate transfer device 20 includes, as major components, the intermediate transfer belt 21 that rotates in a direction indicated by arrow B while passing through a primary transfer position between the photoconductive drum 11 and the primary transfer device 15 (primary transfer roll), a plurality of belt support rolls 22 to 27 that hold the intermediate transfer belt 21 in a desired state from an inner surface thereof and rotatably support the intermediate transfer belt 21, a secondary transfer device 30 serving as an example of a secondary transfer section that is disposed on an outer peripheral surface (image holding surface) side of the intermediate transfer belt 21 supported by the belt support roll 25 and secondarily transfers an toner image on the intermediate transfer belt 21 to the recording paper 5, and a belt cleaning device 28 that removes and cleans deposits such as toner and paper dust remaining on and adhering to the outer peripheral surface of the intermediate transfer belt 21 after passing through the secondary transfer device 30.

As the intermediate transfer belt 21, for example, an endless belt made of a material in which a resistance modifier such as carbon black is dispersed in a synthetic resin such as a polyimide resin or a polyamide resin is used. Additionally, the belt support roll 22 is configured as a drive roll that is rotationally driven by the drive device (not shown) that also serves as a counter roll of the belt cleaning device 28, the belt support roll 23 is configured as a face-out roll that forms an image forming surface of the intermediate transfer belt 21, the belt support roll 24 is configured as a tension applying roll that applies tension to the intermediate transfer belt 21, the belt support roll 25 is configured as a counter roll that faces the secondary transfer device 30, and the belt support rolls 26 and 27 are configured as driven rolls of the intermediate transfer belt 21.

As shown in FIG. 1, the secondary transfer device 30 is a contact type transfer device including a secondary transfer roll 31, which rotates in contact with a peripheral surface of the intermediate transfer belt 21 and is supplied with a secondary transfer voltage, at the secondary transfer position that is an outer peripheral surface portion of the intermediate transfer belt 21 supported by the belt support roll 25 in the intermediate transfer device 20. Additionally, a direct-current voltage showing the opposite polarity or the same polarity as the charging polarity of the toner is supplied to the secondary transfer roll 31 or the belt support roll 25 of the intermediate transfer device 20 from the power supply device (not shown) as the secondary transfer voltage.

The fixing device 40 is configured such that a heating belt 42 that is rotated in a direction indicated by an arrow and heated by a heating section such that the surface temperature is maintained at a predetermined temperature, a pressure roll 43 that is in contact with the heating belt 42 at a predetermined pressure and rotates substantially in an axial direction of the heating belt 42, and the like are disposed inside a housing 41 in which an introduction port and an ejection port of the recording paper 5 are formed. In the fixing device 40, a contact portion where the heating belt 42 and the pressure roll 43 are in contact with each other is a fixing treatment portion that performs a required fixing treatment (heating and pressurizing). In addition, the fixing device 40 will be described in detail below.

The paper feed device 50 is disposed to be present at a position below the image creating device 10 (Y, M, C, K). The paper feed device 50 includes, as major components, a single (or a plurality of) paper accommodation body 51 that accommodates the recording paper 5 of a desired size, type, or the like in a loaded state, and a delivery device 52 that delivers recording paper 5 sheet by sheet from the paper accommodation body 51. The paper accommodation body 51 is attached such that the paper accommodation body 51 can be pulled out to a front side (a side surface facing a user during operation) of the apparatus body 1a, for example.

Examples of the recording paper 5 include thin paper such as plain paper and tracing paper, OHP sheets, or the like, which are used in electrophotographic copying machines and printers. In order to further improve the smoothness of an image surface after fixing, for example, it is preferable that the surface of the recording paper 5 is as smooth as possible. For example, coated paper in which the surface of plain paper is coated with resin or the like, so-called thick paper such as art paper for printing, or the like having a relatively large basis weight can also be appropriately used.

A paper feed transport route 56 including a single or a plurality of paper transport roll pairs 53 and 54, which transport the recording paper 5 delivered from the paper feed device 50 to the secondary transfer position, and a transport guide 55 is provided between the paper feed device 50 and the secondary transfer device 30. The paper transport roll pair 54 disposed at a position immediately before the secondary transfer position in the paper feed transport route 56 is configured as, for example, a roll (registration roll) that adjusts the transport timing of the recording paper 5. Additionally, a paper transport route 57 for transporting the recording paper 5 after the secondary transfer, which is delivered from the secondary transfer device 30, to the fixing device 40 is provided between the secondary transfer device 30 and the fixing device 40. Moreover, an ejection transport route 59 including a paper ejection roll pair 59a for ejecting the recording paper 5 after fixing, which is delivered from the fixing device 40 by an outlet roll 36, to a paper ejection portion 58 on an upper portion of the apparatus body 1a is provided in a portion of the image forming apparatus 1 near the paper ejection port formed in the apparatus body 1a.

Reference sign 200 in FIG. 1 indicates a control device that comprehensively controls the operation of the image forming apparatus 1. The control device 200 includes a central processing unit (CPU), a read only memory (ROM), a random access memory (RAM) (not shown), a bus for connecting the CPU, the ROM, and the like to each other, a communication interface, and the like. Additionally, reference sign 201 indicates a communication unit in which the image forming apparatus 1 communicates with an external device, and reference sign 202 indicates an image processing unit that processes image information input via the communication unit 201.

### Operation of Image Forming Apparatus

Hereinafter, the basic image forming operation by the image forming apparatus 1 will be described.

Here, first, the operation in the full-color mode in which a full-color image configured by combining toner images of four colors (Y, M, C, K) is formed using the four image creating devices 10 (Y, M, C, K) will be is described.

Regarding the image forming apparatus 1, in a case where the control device 200 receives request command information for a full-color image forming operation (printing) from an user interface, a printer driver, or the like (not shown) via the communication unit 201, the control device 200 starts the four image creating devices 10 (Y, M, C, K), the intermediate transfer device 20, the secondary transfer device 30, the fixing device 40, and the like.

Then, in each image creating device 10 (Y, M, C, K), as shown in FIG. 1, each photoconductive drum 11 first rotates in the direction indicated by the arrow A, and each charging device 12 charges the surface of the photoconductive drum 11 to a required polarity (negative polarity in Exemplary Embodiment 1) and a required potential. Subsequently, the exposure device 13 irradiates the surface of the photoconductive drum 11 after charging with light emitted on the basis of image signals obtained by converting the image information input to the image forming apparatus 1 into each color component (Y, M, C, K) by the image processing unit 202, and forms an electrostatic latent image of each color component configured with a required potential difference on the surface thereof.

Subsequently, each image creating device 10 (Y, M, C, K) supplies a toner of a corresponding color (Y, M, C, K) charged with a required polarity (negative polarity) from the developing roll 141 to the electrostatic latent image of each color component formed on the photoconductive drum 11 and causes the toner to electrostatically adhere to the electrostatic latent image for development. By virtue of this development, the electrostatic latent images of the respective color components formed on the respective photoconductive drums 11 are developed as toner images of four colors (Y, M, C, K) developed with the toners of the corresponding colors.

Subsequently, in a case where the toner image of each color formed on the photoconductive drum 11 of each image creating device 10 (Y, M, C, K) is transported to the primary transfer position, the primary transfer device 15 (Y, M, C, K) primarily transfers the toner image of each color in a state in which the toner image of each color is sequentially superimposed on the intermediate transfer belt 21 while rotating in the direction indicated by the arrow B of the intermediate transfer device 20.

Additionally, in each image creating device 10 (Y, M, C, K) in which the primary transfer is completed, the drum cleaning device 16 removes deposits to scrape off the deposits and cleans the surface of the photoconductive drum 11. Accordingly, each image creating device 10 (Y, M, C, K) is in a state in which the next image creating operation can be performed.

Subsequently, the intermediate transfer device 20 holds the toner image that is primarily transferred by the rotation of the intermediate transfer belt 21 and transports the toner image to the secondary transfer position. Meanwhile, in the paper feed device 50, the required recording paper 5 is delivered to the paper feed transport route 56 in conformity with the image creating operation. In the paper feed transport route 56, the paper transport roll pair 54 serving as the registration roll delivers and supplies the recording paper 5 to the secondary transfer position in conformity with a transfer timing.

At the secondary transfer position, the secondary transfer device 30 collectively secondarily transfers the toner image on the intermediate transfer belt 21 to the recording paper 5. Additionally, in the intermediate transfer device 20 in which the secondary transfer is completed, the belt cleaning device 28 removes and cleans the deposits such as toner remaining on the surface of the intermediate transfer belt 21 after the secondary transfer. Subsequently, the recording paper 5 on which the toner image is secondarily transferred is peeled off from the intermediate transfer belt 21 and then transported to the fixing device 40 via the paper transport route 57. In the fixing device 40, by introducing and passing the recording paper 5 after the secondary transfer into and through the contact portion between the rotating heating belt 42 and the pressure roll 43, the required fixing treatment (heating and pressurizing) is performed, and an unfixed toner image is fixed on the recording paper 5. Finally, the recording paper 5 after the fixing is completed is ejected to, for example, the paper ejection portion 58 installed in the upper portion of the apparatus body 1a by the paper ejection roll pair 59a.

By the above operation, the recording paper 5 on which the full-color image configured by combining the toner images of four colors is formed is output.

### Configuration of Fixing Device

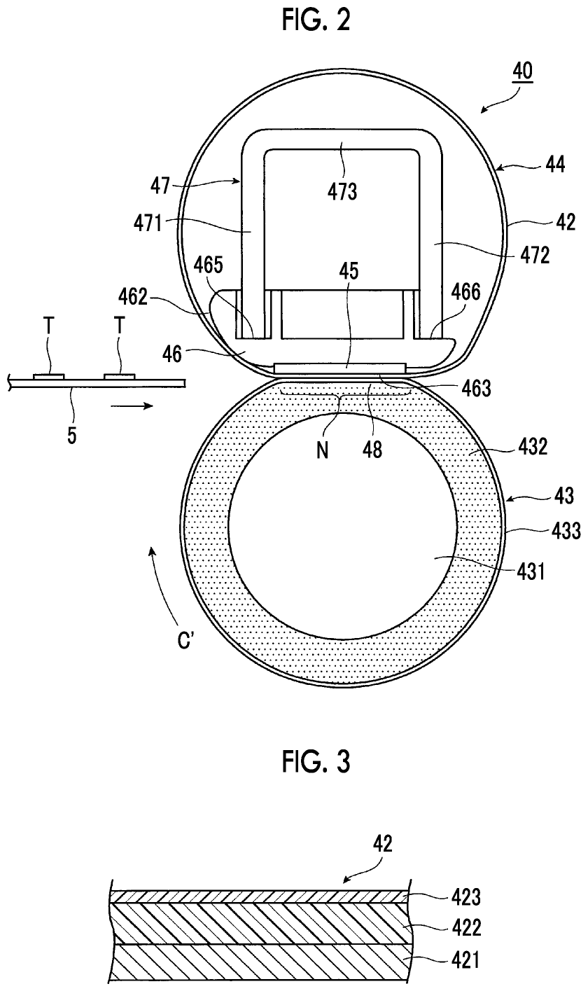

FIG. 2 is a cross-sectional configuration diagram showing the fixing device according to Exemplary Embodiment 1.

As the fixing device 40, a so-called free belt nipping type fixing device has been adopted. As shown in FIG. 2, the fixing device 40 mainly includes a heating unit 44 having the heating belt 42 serving as an example of an endless-belt-shaped fixing section that is rotatably provided, and the pressure roll 43 serving as an example of a pressurizing section being in pressure contact with the heating unit 44. A fixing nip portion N, which is a region through which the recording paper 5 serving as an example of a heating target (fixation target member) holding an unfixed toner image T serving as an example of an unfixed image passes, is formed between the heating belt 42 and the pressure roll 43. In addition, the recording paper 5 is transported with a center in a direction intersecting a transport direction as a reference (so-called center registration).

As shown in FIG. 2, the heating unit 44 includes the heating belt 42, a ceramic heater 45 that is a planar heat-generating member disposed inside the heating belt 42 and heating the heating belt 42 and that serves as a supporting section supporting an inner peripheral surface of the heating belt 42, a pad member 46 serving as an example of a pressure contact section that is also disposed inside the heating belt 42 and causes the ceramic heater 45 to be in pressure contact with a surface of the pressure roll 43 via the heating belt 42, a holding member 47 serving as an example of a holding section that is also disposed inside the heating belt 42 and holds the pad member 46 to be in pressure contact with the pressure roll 43, and fluorine grease 48 serving as an example of a lubricant interposed between the heating belt 42 and the ceramic heater 45 at the fixing nip portion N.

Only a predetermined amount of the fluorine grease 48 serving as an example of the lubricant is applied to be interposed between the heating belt 42 and the ceramic heater 45 at the time of assembly of the fixing device 40. As use of the fixing device 40 is started, the fluorine grease 48, which is a viscoelastic body, flows out little by little from a region between the heating belt 42 and the ceramic heater 45 in a state of adhering to the inner peripheral surface of the heating belt 42 as the heating belt 42 is rotated. As the heating belt 42 is rotated, the fluorine grease 48 adhering to the inner peripheral surface of the heating belt 42 flows again into the fixing nip portion N where the heating belt 42 and the ceramic heater 45 are in pressure contact with each other.

In addition, in the ceramic heater 45 serving as an example of the planar heat-generating member, as will be described later, a heat-generating portion itself does not need to be planar and the heat-generating portion may be linearly formed as long as a lower end surface of the ceramic heater 45 that heats the heating belt 42 is planar.

The heating belt 42 is made of a material having flexibility and is configured as an endless belt in which a free shape thereof is thin-walled cylindrical in a state before mounting. As shown in FIG. 3, the heating belt 42 includes a base material layer 421, an elastic body layer 422 coated on a surface of the base material layer 421, and a release layer 423 coated on a surface of the elastic body layer 422. The heating belt 42 includes the elastic body layer 422 on a surface side thereof, and a surface layer including the elastic body layer 422 is configured to be elastically deformable. The base material layer 421 is formed of a heat-resistant synthetic resin such as polyimide, polyamide, or polyamideimide, or a thin metal such as stainless steel, nickel, and copper. The elastic body layer 422 is made of a heat-resistant elastic body such as silicone rubber or fluororubber. The release layer 423 is formed of perfluoroalkoxyalkane (PFA), polytetrafluoroethylene (PTFE), or the like. The thickness of the heating belt 42 can be set to, for example, about 100 to 600 μm.

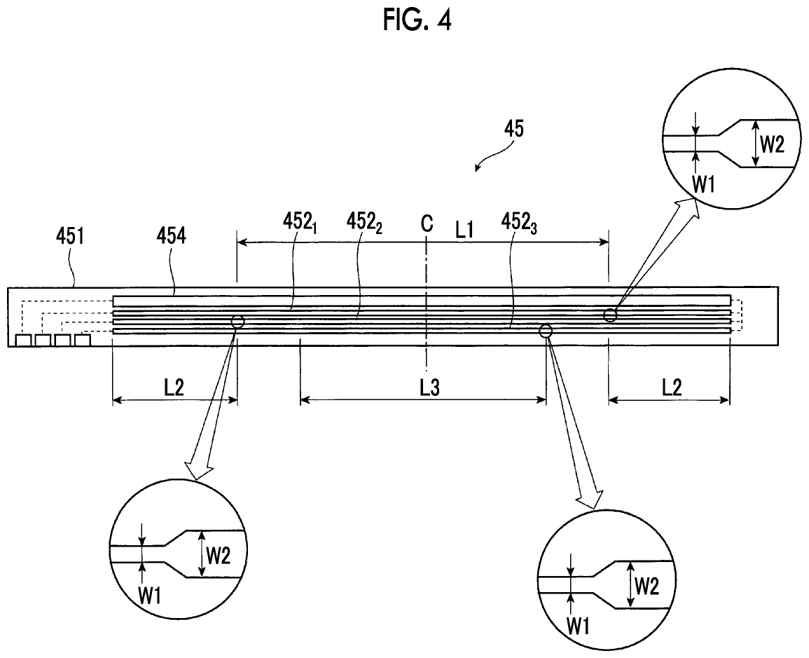

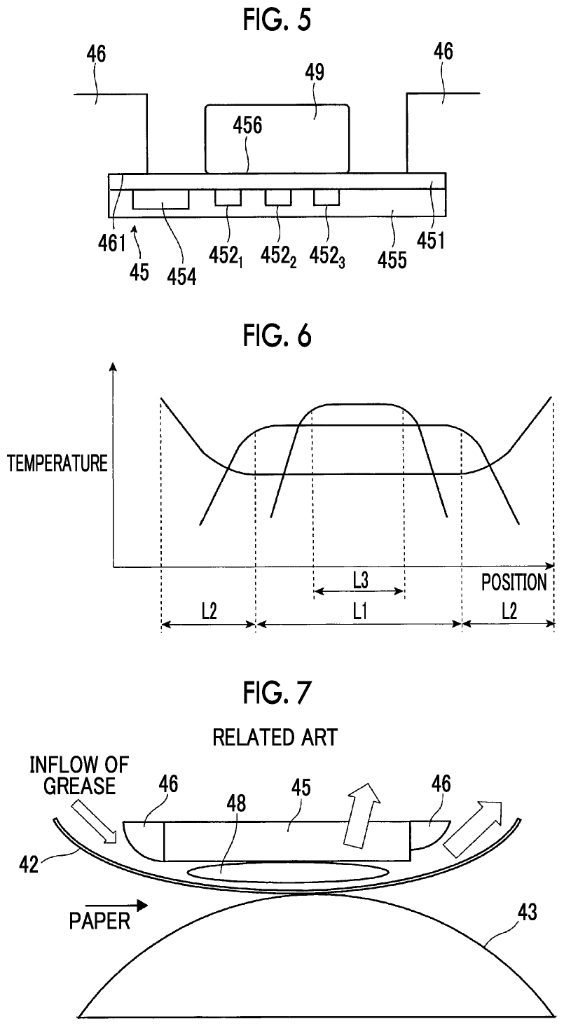

As shown in FIGS. 4 and 5, the ceramic heater 45 includes a ceramic substrate 451, a plurality of first to third heat-generating portions 452₁ to 452₃ linearly formed in the longitudinal direction on the surface of the substrate 451, a common energization electrode 454 for individually energizing the first to third heat-generating portions 452₁ to 452₃, and a coating layer 455 that is coated on surfaces of the first to third heat-generating portions 452₁ to 452₃ and the energization electrode 454 and that is made of glass.

As shown in FIG. 4, the first to third heat-generating portions 452₁ to 452₃ and the energization electrode 454 are disposed to be parallel to each other along a width direction of the substrate 451. Regarding the first to third heat-generating portions 452₁ to 452₃. the line widths and/or the thicknesses of heat-generating materials constituting the first to third heat-generating portions 452₁ to 452₃ are made different from each other so that heat-generating regions along the longitudinal direction of the first to third heat-generating portions 452₁ to 452₃ are set to be different from each other. In addition, the lengths of the first to third heat-generating portions 452₁ to 452₃ are set to be equal in the longitudinal direction.

Regarding the first heat-generating portion 452₁, the line width of a heat-generating material in a region of a length L1, which is positioned at a center C of the heat-generating region, is set to be small for large electrical resistance so that heat is generated over the region of the length L1 right and left with respect to the center C of the heat-generating region in the longitudinal direction. Regarding the first heat-generating portion 452₁, the line widths of heat-generating materials in regions positioned at both end portions of the length L1 are set to be large for small electrical resistance so that heat is not generated or a very small amount of heat is generated even in the case of heat generation.

Regarding the second heat-generating portion 452₂, contrary to the first heat-generating portion 452₁, the line widths of heat-generating materials in regions other than the length L1, which are positioned to the right and the left of the center C in the longitudinal direction, are set to be small so that heat is generated over the regions other than the length L1 right and left with respect to the center C in the longitudinal direction. Regarding the second heat-generating portion 452₂, the line widths of heat-generating materials in regions positioned at both end portions of the length L1 are set to be large so that heat is not generated or a very small amount of heat is generated even in the case of heat generation.

Regarding the third heat-generating portion 452₃, unlike the first and second heat-generating portions 452₁ and 452₂, the line width of a heat-generating material in a region of a length L3, which is positioned at the center C of the heat-generating region, is set to be small for large electrical resistance so that heat is generated over the region of the length L3 right and left with respect to the center C of the heat-generating region in the longitudinal Regarding the third heat-generating portion 452₃, the line widths of direction. heat-generating materials in regions positioned at both end portions of the length L3 are set to be large for small electrical resistance so that heat is not generated or a very small amount of heat is generated even in the case of heat generation.

As shown in FIG. 5, the energization electrode 454 is formed to have a large layer thickness in comparison with the first to third heat-generating portions 452₁ to 452₃. In addition, the energization electrode 454 is disposed to be positioned closer to an upstream side in a rotational direction of the heating belt 42 than the first to third heat-generating portions 452₁ to 452₃ are. Furthermore, the energization electrode 454 is disposed such that the central position thereof in the width direction coincides with an upstream-side end portion of the fixing nip portion N.

FIG. 6 is a graph schematically showing the heat generation temperatures of the first to third heat-generating portions 452₁ to 452₃.

As shown in FIG. 6, the first heat-generating portion 452₁ generates heat over the region of the length L1 right and left with respect to the center C of the heat-generating region in the longitudinal direction such that a set temperature set in advance is reached. The second heat-generating portion 452₂ generates heat over the regions other than the length L1 right and left with respect to the center C in the longitudinal direction such that a set temperature set in advance is reached. The third heat-generating portion 452₃ generates heat over the region of the length L3 right and left with respect to the center C of the heat-generating region in the longitudinal direction such that a set temperature set in advance is reached.

As shown in FIG. 4, the first heat-generating portion 452₁ is used to heat and fix the medium-length recording paper 5 of which a length in a direction intersecting the transport direction of the recording paper 5 is L1.

The second heat-generating portion 452₂ is used at the same time as the first heat-generating portion 452₁ to heat and fix the large-size recording paper 5 of which a length in the direction intersecting the transport direction of the recording paper 5 is L1 +2·L2.

The third heat-generating portion 452₃ is used to heat and fix the smallest-size recording paper 5 of which a length in the direction intersecting the transport direction of the recording paper 5 is L3.

As shown in FIG. 2, the holding member 47 is made of, for example, a metallic plate material such as stainless steel, aluminum, or steel. The holding member 47 is formed to have a substantially U-like cross-sectional shape formed by vertical plate portions 471 and 472 that are disposed substantially perpendicular to the surface of the ceramic heater 45 on the upstream side and the downstream side of the fixing nip portion N in the rotational direction of the heating belt 42, and a horizontal plate portion 473 that is disposed in the horizontal direction to connect base end portions of the vertical plate portions 471 and 472.

The temperature of the fixing nip portion N of the heating belt 42 is detected by a temperature sensor 49 that is disposed to be in contact with the surface of the ceramic heater 45 opposite to the fixing nip portion N. As described above, the ceramic heater 45 includes the first to third heat-generating portions 452₁ to 452₃ having different heat-generating regions in the longitudinal direction. For that reason, a plurality (for example, three) of temperature sensors 49 are disposed in the longitudinal direction of the ceramic heater 45 in correspondence with the first to third heat-generating portions 452₁ to 452₃. The heating belt 42 is heated such that the fixing nip portion N reaches a required fixing temperature (for example, about 200° C.) depending on the size of the recording paper 5 by controlling the energization of the first to third heat-generating portions 452₁ to 452₃ of the ceramic heater 45 on the basis of the detection result of the temperature sensor by a temperature control circuit (not shown).

As shown in FIG. 2, the pad member 46 is made of, for example, a heat-resistant synthetic resin integrally molded into a required shape by injection molding or the like. Examples of the heat-resistant synthetic resin include liquid crystal polymer (LCP), polyetheretherketone (PEEK), polyphenylene sulfide (PPS), polyethersulfone (PES), polyamideimide (PAI), polytetrafluoroethylene (PTFE), polychlorotrifluoroethylene (PCTFE), polyvinylidene fluoride (PVDF), or a composite material thereof.

The pad member 46 has a support recess portion 461 that supports the ceramic heater 45 to pressurize the pressure roll 43 via the heating belt 42 at the fixing nip portion N and has an elongated rectangular shape corresponding to the planar shape of the ceramic heater 45. The pad member 46 is disposed to be longer than the total length in the longitudinal direction of the heating belt 42. Note that the pad member 46 is disposed in a non-contact state of being not in contact with the heating belt 42 at the fixing nip portion N.

As shown in FIG. 2, the pad member 46 is provided with a first guide portion 462 that is formed to have a curved cross-sectional shape and guides the heating belt 42 to the fixing nip portion N on an upstream side with respect to the fixing nip portion N in the rotational direction of the heating belt 42. As shown in FIG. 2, the pad member 46 comes into contact with the heating belt 42 at the first guide portion 462 that is on the upstream side with respect to the fixing nip portion N in the rotational direction of the heating belt 42 so as to regulate the posture (shape) of the heating belt 42 entering the fixing nip portion N to be in a predetermined state.

Additionally, as shown in FIG. 2, the pad member 46 is provided with abutment portions 465 and 466 where tips of vertical plate portions 471 and 472 of the holding member 47 abut against a surface of the pad member 46 that is opposite to the fixing nip portion N.

As shown in FIG. 2, the pressure roll 43 has a columnar or cylindrical core metal 431 made of metal such as stainless steel, aluminum, or iron (thin-walled high-tension steel pipe), an elastic body layer 432 made of a heat-resistant elastic body such as silicone rubber or fluororubber relatively thickly coated at an outer periphery of the core metal 431, and a release layer 433 made of polytetrafluoroethylene (PTFE), perfluoroalkoxyalkane (PFA), or the like thinly coated on the surface of the elastic body layer 432. In addition, as necessary, a heating section (heating source) including a halogen lamp or the like may be disposed inside the pressure roll 43.

Both end portions in the longitudinal direction (axial direction) of the pressure roll 43 are rotatably supported by a frame of a device housing (not shown) of the fixing device 40 via a bearing member. The pressure roll 43 is configured to be brought into pressure contact with a lower end surface of the ceramic heater 45 by a pressurizing mechanism (not shown) with a required pressing force, the ceramic heater 45 being held by the pad member 46. The pressure roll 43 is rotationally driven at a required speed in a direction of arrow C by the drive device via a drive gear (not shown) attached to one end portion in an axial direction of the core metal 431 that also serves as a rotation shaft. In addition, the heating belt 42 is in pressure contact with the rotationally driven pressure roll 43 and rotates in a driven manner.

As shown in FIG. 2, in the case of the fixing device 40 configured as described above, the heating belt 42 that is heated by the ceramic heater 45 is used as the heating section. The heating belt 42 is a thin-walled cylindrical member, has a smaller heat capacity than a heating roll, has a shorter warm-up time between the start of heating and a time, at which a temperature at which fixing is possible, is reached, and is widely used in the image forming apparatus 1.

As described above, in the fixing device 40 as described above, for reduction of sliding friction between the inner peripheral surface of the heating belt 42 and the surface of the ceramic heater 45 and improvement of thermal conductivity with efficient transfer of heat of the ceramic heater 45 to the inner peripheral surface of the heating belt 42, the fluorine grease 48 is interposed between the heating belt 42 and the ceramic heater 45 at the fixing nip portion N.

Meanwhile, as shown in FIG. 7, regarding the fluorine grease 48 interposed between the heating belt and the ceramic heater 45, a portion of the fluorine grease 48 adheres to the inner peripheral surface of the heating belt 42 and flows out to the outside of the fixing nip portion N as the heating belt 42 is rotated and flows into the fixing nip portion N again as the heating belt 42 is rotated. At this time, there is a portion of the fluorine grease 48 that flows out from both end portions in the longitudinal direction or both end portions in the width direction of the ceramic heater 45 without being re-supplied into the fixing nip portion N as the heating belt 42 is rotated.

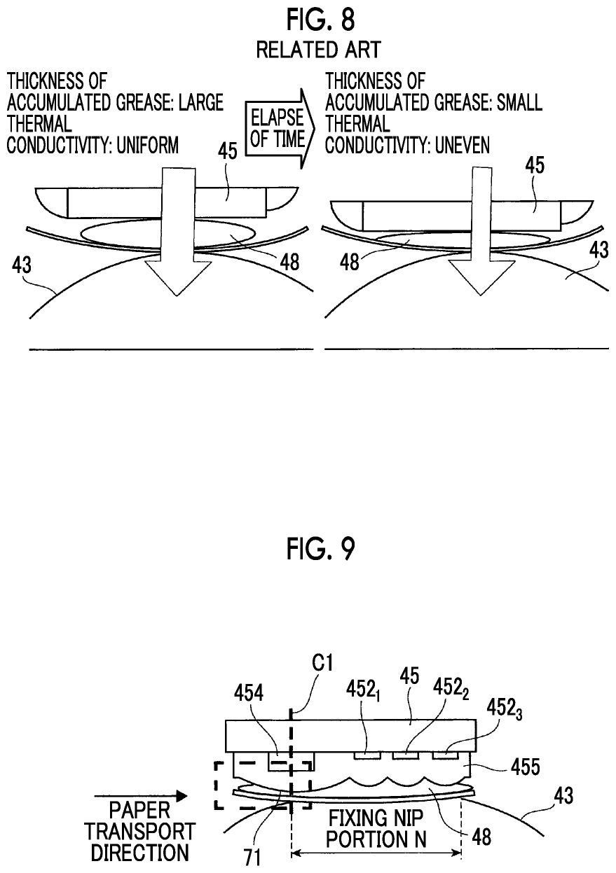

Therefore, as the fixing device 40 is operated, the amount of the fluorine grease 48 flowing out without being re-supplied into the fixing nip portion N increases with time. As a result, as shown in FIG. 8, the amount of the fluorine grease 48 re-supplied into the fixing nip portion N decreases, and the amount of the accumulated fluorine grease 48 present in the fixing nip portion decreases.

In a case where the amount of the accumulated fluorine grease 48 present in the fixing nip portion N is reduced as described above, since the fluorine grease 48 is for reduction of sliding friction and improvement of thermal conductivity as described above, there is slight unevenness in thermal conductivity between the ceramic heater 45 and the heating belt 42, which influences a local variation in surface temperature of the heating belt 42. In addition, there is also a local unevenness in degree to which an unfixed toner image on the recording paper 5 heated and pressurized by the heating belt 42 and the pressure roll 43 in the fixing nip portion Nis melted. Therefore, there is a technical problem that the unevenness is realized as gloss unevenness of a toner image fixed on the recording paper 5.

The gloss unevenness of the toner image fixed on the recording paper 5 tends to occur at a relatively early stage of the start of use of the fixing device 40 over time.

Therefore, the fixing device according to Exemplary Embodiment 1 is configured to include a lubricant storing portion that is provided at an inlet of the fixing nip portion of a supporting section such that the width of a gap between a fixing section and the lubricant storing portion gradually decreases along a rotational direction of the fixing section and that stores a lubricant.

In addition, in the fixing device according to Exemplary Embodiment 1, the lubricant storing portion is provided at a position corresponding to an energization electrode that is disposed upstream of a heat-generating element in the rotational direction of the fixing section.

Furthermore, in the fixing device according to Exemplary Embodiment 1, the lubricant storing portion is composed of a protruding portion provided to protrude toward a pressure contact section at the inlet of the fixing nip portion of the supporting section.

That is, as shown in FIGS. 2 and 9, the fixing device 40 according to Exemplary Embodiment 1 includes a lubricant storing portion 70 that is provided at an inlet of the fixing nip portion N of the ceramic heater 45 such that the width of a gap G between the heating belt 42 and the lubricant storing portion 70 gradually decreases along the rotational direction of the heating belt 42 and that stores the fluorine grease 48.

The lubricant storing portion 70 is provided at a position corresponding to the energization electrode 454 that is disposed upstream of the first to third heat-generating portions 452₁ to 452₃ of the ceramic heater 45 in the rotational direction of the heating belt 42.

More specifically, as shown in FIGS. 5 and 9, after patterning is performed on a surface of the substrate 451 consisting of a ceramic aluminum substrate or the like by using a conductive material for formation of the first to third heat-generating portions 452₁ to 452₃ and the energization electrode 454, the substrate 451 with the first to third heat-generating portions 452₁ to 452₃ and the energization electrode 454 formed thereon is subjected to firing or the like and surfaces of the first to third heat-generating portions 452₁ to 452₃ and the energization electrode 454 are coated by the coating layer 455 made of a glass material or the like so that the ceramic heater 45 is formed.

At this time, for reduction of electrical resistance, the energization electrode 454 of the ceramic heater 45 is formed to be thicker than the first to third heat-generating portions 452₁ to 452₃. In addition, the coating layer 455 coated on the surface of the energization electrode 454 of the ceramic heater 45 is configured to form a protruding portion 71 that protrudes toward the pressure roll 43 in a mountain-like shape that is curved such that a central position in a width direction of the coating layer 455 is high in comparison with the first to third heat-generating portions 452₁ to 452₃. The coating layer 455 also forms similar mountain-like shapes even at positions corresponding to the first to third heat-generating portions 452₁ to 452₃.

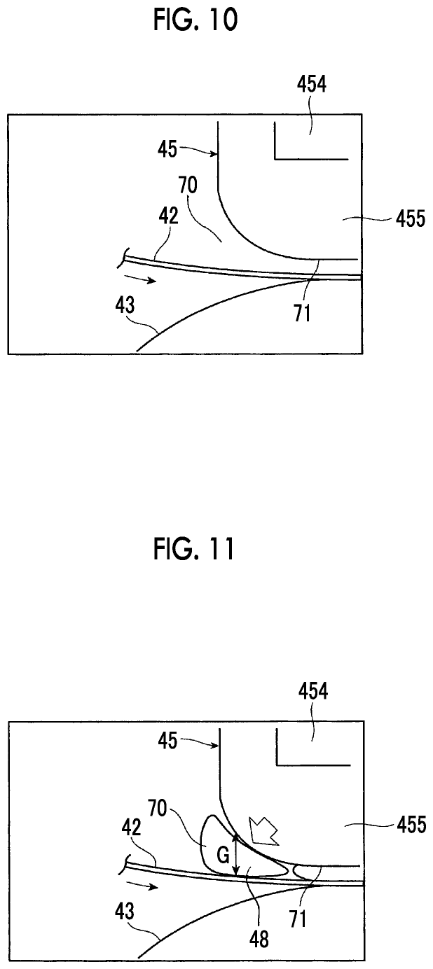

In addition, in Exemplary Embodiment 1, as shown in FIGS. 9 and 10, the ceramic heater 45 is disposed such that a position where the protruding portion 71 of the coating layer 455 of the ceramic heater 45 protrudes most coincides with the inlet of the fixing nip portion N.

In a region close to the inlet of the fixing nip portion N of the ceramic heater 45, the posture of the heating belt 42 is regulated by the pad member 46 and the lubricant storing portion 70 is formed such that the width of a gap between the heating belt 42 and the lubricant storing portion 70 gradually decreases toward a downstream side in the rotational direction of the heating belt 42 along the protruding portion 71 of the coating layer 455 of the ceramic heater 45.

The fluorine grease 48 that adheres to the inner peripheral surface of the heating belt 42 and flows out consists of a viscoelastic body, rotates together with the heating belt 42, and flows into the fixing nip portion N.

In this case, since the inlet of the fixing nip portion N is provided with the lubricant storing portion 70, the fluorine grease 48 flowing into the fixing nip portion N stays at the lubricant storing portion 70 and is stored at the lubricant storing portion 70 while passing through the lubricant storing portion 70 with the gap, of which the width gradually decreases, and the fluorine grease 48 flows into the fixing nip portion N little by little since lubrication is caused by a pressure generated by a shearing stress received due to a wedge effect of the lubricant storing portion 70.

Action of Fixing Device

In the case of the fixing device according to Exemplary Embodiment 1 as follows, the occurrence of gloss unevenness on a recording medium accompanied by a decrease in amount of a lubricant interposed between a supporting section and a fixing section may be suppressed in comparison with a case where a lubricant storing portion provided at an inlet of a fixing nip portion of the supporting section is not provided.

That is, as shown in FIGS. 9 and 11, in the fixing device 40 according to Exemplary Embodiment 1, the lubricant storing portion 70 is provided at the inlet of the fixing nip portion N of the ceramic heater 45. Therefore, the fluorine grease 48 supplied to be interposed between the heating belt 42 and the ceramic heater 45 flows out from the fixing nip portion N as the heating belt 42 is rotated and adheres to the inner peripheral surface of the heating belt 42 to flow into the fixing nip portion N again at an initial stage. However, a portion of the fluorine grease 48 flowing into the fixing nip portion N is stored at the lubricant storing portion 70.

Meanwhile, in the fixing device 40, as shown in FIG. 2, there is fluorine grease that flows out from both end portions in the longitudinal direction or both end portions in the width direction of the ceramic heater 45 with time without being re-supplied into the fixing nip portion N as the heating belt 42 is rotated. However, a portion of the fluorine grease 48 supplied to be interposed between the ceramic heater 45 and the heating belt 42 is stored at the lubricant storing portion 70. In addition, the fluorine grease 48 stored at the lubricant storing portion 70 is supplied again to the inside of the fixing nip portion N.

As a result, with the fixing device 40, even in a case where there is fluorine grease that flows out from both end portions in the longitudinal direction or both end portions in the width direction of the ceramic heater 45 with time, the amount of the fluorine grease 48 re-supplied into the fixing nip portion N may be secured in total and the occurrence of gloss unevenness of a toner image fixed on the recording paper 5 which is accompanied by a decrease in amount of the fluorine grease 48 interposed between the ceramic heater 45 and the heating belt 42 may be suppressed in comparison with a case where the lubricant storing portion 70 is not provided.

In addition, in the above exemplary embodiments, the case where the ceramic heater is used as the planar heat-generating section has been described, but the planar heat-generating section is not limited to the ceramic heater, and anything that generates heat literally in a planar manner at the fixing nip portion N may be used.

Additionally, in the above-described exemplary embodiments, the case where the pressure roll is used as the pressurizing section has been described, but a pressure belt may be used as the pressurizing section.

### Supplementary Note

(((1)))

A fixing device comprising:
an endless-belt-shaped fixing section that is rotatably provided;
a supporting section that is disposed inside the fixing section and that supports an inner peripheral surface of the fixing section;
a pressure contact section that is in pressure contact with the supporting section at a fixing nip portion via the fixing section;
a lubricant that is interposed between the supporting section and the fixing section; and
a lubricant storing portion that is provided at an inlet of the fixing nip portion of the supporting section such that a width of a gap between the fixing section and the lubricant storing portion gradually decreases along a rotational direction of the fixing section and that stores the lubricant.
(((2)))

The fixing device according to (((1))),
wherein the supporting section consists of a heat-generating element that is linearly disposed in a longitudinal direction intersecting the rotational direction of the fixing section, an energization electrode that is linearly disposed in the longitudinal direction intersecting the rotational direction of the fixing section and that energizes the heat-generating element, and a planar heat-generating member that includes a protection layer for protection of the heat-generating element and the energization electrode.
(((3)))

The fixing device according to (((2))),
wherein the lubricant storing portion is provided at a position corresponding to the energization electrode that is disposed upstream of the heat-generating element in the rotational direction of the fixing section.
(((4)))

The fixing device according to (((1))),
wherein the lubricant storing portion consists of a protruding portion provided to protrude toward the pressure contact section at the inlet of the fixing nip portion of the supporting section.
(((5)))

The fixing device according to (((4))),
wherein a position where the protruding portion protrudes toward the pressure contact section most is at an inlet-side end portion of the fixing nip portion.
(((6)))

The fixing device according to (((4))),
wherein the protruding portion is provided to have a curved cross-sectional shape such that the protruding portion protrudes toward the pressure contact section.
(((7)))

The fixing device according to (((4))),
wherein the protruding portion causes the lubricant to be stored and to flow into the fixing nip portion by means of a shearing stress that increases as the lubricant moving in a state of adhering to the inner peripheral surface of the fixing section passes through the gap that is provided such that a width thereof gradually decreases along the rotational direction of the fixing section.
(((8)))

The fixing device according to (((1))),
wherein the fixing section maintains a state of being separated from the supporting section in a case where the fixing section enters the fixing nip portion.
(((9)))

The fixing device according to (((8))),
wherein the fixing section is guided by a guide section disposed upstream of the fixing nip portion.
(((10)))

An image forming apparatus comprising:
an image forming section that forms an image on a recording medium; and
a fixing section that fixes the image on the recording medium,
wherein the fixing section is the fixing device according to any one of (((1))) to (((9))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
an endless-belt-shaped fixing section that is rotatably provided;
a supporting section that is disposed inside the fixing section and that supports an inner peripheral surface of the fixing section;
a pressure contact section that is in pressure contact with the supporting section at a fixing nip portion via the fixing section;
a lubricant that is interposed between the supporting section and the fixing section; and
a lubricant storing portion that is provided at an inlet of the fixing nip portion of the supporting section such that a width of a gap between the fixing section and the lubricant storing portion gradually decreases along a rotational direction of the fixing section and that stores the lubricant.

2. The fixing device according to claim 1,
wherein the supporting section consists of a heat-generating element that is linearly disposed in a longitudinal direction intersecting the rotational direction of the fixing section, an energization electrode that is linearly disposed in the longitudinal direction intersecting the rotational direction of the fixing section and that energizes the heat-generating element, and a planar heat-generating member that includes a protection layer for protection of the heat-generating element and the energization electrode.

3. The fixing device according to claim 2,
wherein the lubricant storing portion is provided at a position corresponding to the energization electrode that is disposed upstream of the heat-generating element in the rotational direction of the fixing section.

4. The fixing device according to claim 1,
wherein the lubricant storing portion consists of a protruding portion provided to protrude toward the pressure contact section at the inlet of the fixing nip portion of the supporting section.

5. The fixing device according to claim 4,
wherein a position where the protruding portion protrudes toward the pressure contact section most is at an inlet-side end portion of the fixing nip portion.

6. The fixing device according to claim 4,
wherein the protruding portion is provided to have a curved cross-sectional shape such that the protruding portion protrudes toward the pressure contact section.

7. The fixing device according to claim 4,
wherein the protruding portion causes the lubricant to be stored and to flow into the fixing nip portion by means of a shearing stress that increases as the lubricant moving in a state of adhering to the inner peripheral surface of the fixing section passes through the gap that is provided such that a width thereof gradually decreases along the rotational direction of the fixing section.

8. The fixing device according to claim 1,
wherein the fixing section maintains a state of being separated from the supporting section in a case where the fixing section enters the fixing nip portion.

9. The fixing device according to claim 8,
wherein the fixing section is guided by a guide section disposed upstream of the fixing nip portion.

10. An image forming apparatus comprising:
an image forming section that forms an image on a recording medium; and
a fixing section that fixes the image on the recording medium,
wherein the fixing section is the fixing device according to claim 1.

11. An image forming apparatus comprising:
an image forming section that forms an image on a recording medium; and
a fixing section that fixes the image on the recording medium,
wherein the fixing section is the fixing device according to claim 2.

12. An image forming apparatus comprising:
an image forming section that forms an image on a recording medium; and
a fixing section that fixes the image on the recording medium,
wherein the fixing section is the fixing device according to claim 3.

13. An image forming apparatus comprising:
an image forming section that forms an image on a recording medium; and
a fixing section that fixes the image on the recording medium,
wherein the fixing section is the fixing device according to claim 4.

14. An image forming apparatus comprising:
an image forming section that forms an image on a recording medium; and
a fixing section that fixes the image on the recording medium,
wherein the fixing section is the fixing device according to claim 5.

15. An image forming apparatus comprising:
an image forming section that forms an image on a recording medium; and
a fixing section that fixes the image on the recording medium,
wherein the fixing section is the fixing device according to claim 6.

16. An image forming apparatus comprising:
an image forming section that forms an image on a recording medium; and
a fixing section that fixes the image on the recording medium,
wherein the fixing section is the fixing device according to claim 7.

17. An image forming apparatus comprising:
an image forming section that forms an image on a recording medium; and
a fixing section that fixes the image on the recording medium,
wherein the fixing section is the fixing device according to claim 8.

18. An image forming apparatus comprising:
an image forming section that forms an image on a recording medium; and
a fixing section that fixes the image on the recording medium,
wherein the fixing section is the fixing device according to claim 9.

19. A fixing device comprising:
endless-belt-shaped fixing means that is rotatably provided;
supporting means for supporting an inner peripheral surface of the fixing section, the supporting means being disposed inside the fixing section;
pressure contact means that is in pressure contact with the supporting section at a fixing nip portion via the fixing section;
a lubricant that is interposed between the supporting section and the fixing section; and
a lubricant storing portion that is provided at an inlet of the fixing nip portion of the supporting section such that a width of a gap between the fixing section and the lubricant storing portion gradually decreases along a rotational direction of the fixing section and that stores the lubricant.
